(19) United States
(12) Patent Application Publication
(10) Pub. No.: US 2021/0005970 A1
(43) Pub. Date: Jan. 7, 2021

(54) SLOT ANTENNA APPARATUS, AND METHOD FOR ADJUSTING AMOUNT OF RADIO WAVES EMITTED FROM SLOT ANTENNA APPARATUS

(71) Applicant: FUJITSU LIMITED, Kawasaki-shi (JP)

(72) Inventor: Shigekazu KIMURA, Yokohama (JP)

(73) Assignee: FUJITSU LIMITED, Kawasaki-shi (JP)

(21) Appl. No.: 16/905,070

(22) Filed: Jun. 18, 2020

(30) Foreign Application Priority Data
Jul. 2, 2019 (JP) 2019-123940

(51) Int. Cl. H01Q 13/10; H01Q 21/08

(52) U.S. Cl. CPC H01Q 13/10; H01Q 21/08

(57) ABSTRACT

A slot antenna apparatus that includes a waveguide including a sidewall having an edge, a first slot provided on the sidewall, a second slot provided on the sidewall, and a first dielectric member mountable in the first slot or the second slot, the first dielectric member having a first dielectric property.

### CROSS-REFERENCE TO RELATED APPLICATION

This patent application is based upon and claims the benefit of priority of the prior Japanese Patent Application No. 2019-123940 filed on Jul. 2, 2019, the entire contents of which are incorporated herein by reference.

### FIELD

The embodiment discussed herein is related to a slot antenna apparatus, and a method for adjusting the amount of radio waves emitted from the slot antenna apparatus.

### BACKGROUND

Conventionally, a slotted waveguide antenna is used to receive circularly polarized waves. The slotted waveguide antenna includes a lower conductive plate, an intermediate conductive plate and an upper conductive plate. The lower conductive plate and the intermediate conductive plate are coupled to each other to form a feeding line and a waveguide to which satellite frequency signals are transmitted. The upper conductive plate is coupled to an upper portion of the intermediate conductive plate and has a plurality of cavities and slots, which communicate with the waveguide to transmit and receive satellite frequency signals. The slotted waveguide antenna further includes a polarizer and a dielectric plate. The polarizer is stacked on the upper conductive plate and has strip conductors and matching stubs for converting linearly polarized waves into circularly polarized waves. The dielectric plate is disposed between the upper conductive plate and the polarizer to perform impedance matching with space impedance (for example, see Patent Document 1).

There is a dielectric waveguide slot array antenna that includes a dielectric waveguide, a printed circuit board, and a metallic plate. Such dielectric waveguide has a plurality of first slots that emit electromagnetic waves at designated intervals to a surface. The printed circuit board has first through-holes located at positions opposite to the first slots respectively. The metallic plate has first penetrating holes located at positions opposite to the first slots respectively. The dielectric waveguide has a plurality of second slots formed close to the plurality of respective first slots. The printed circuit board has second through-holes located at positions opposite to the second slots respectively. The metallic plate has second penetrating holes located at positions opposite to the second slots respectively (for example, see Patent Document 2).

There is a corrugated leaky waveguide that includes a hollow conductor and through-holes formed on the hollow conductor. The through-holes are provided for leaking radio waves and are disposed at intervals in a longitudinal direction. Recesses and projections are provided in the longitudinal direction on the surface of the conductor. Either or both of the intervals of the through-holes and pitches of the recesses and the projections are irregular (for example, see Patent Document 3).

However, none of the documents describes that a slot antenna apparatus including a waveguide having a plurality of slots may be used to adjust the amount of radio waves emitted from each of the slots.

### RELATED-ART DOCUMENTS

### Patent Documents

[Patent Document 1] Japanese National Publication of International Patent Application No. 2011-503996
[Patent Document 2] Japanese Laid-open Patent Publication No. 2005-217864
[Patent Document 3] Japanese Laid-open Patent Publication No. 2000-068733

### SUMMARY

According to an aspect of the present application, there is provided a slot antenna apparatus that includes a waveguide including a sidewall having an edge, a first slot provided on the sidewall, a second slot provided on the sidewall, and a first dielectric member mountable in the first slot or the second slot, the first dielectric member having a first dielectric property.

The object and advantages of the disclosure will be realized and attained by means of the elements and combinations particularly pointed out in the claims.

It is to be understood that both the foregoing general description and the following detailed description are exemplary and explanatory and are not restrictive of the invention as claimed.

### BRIEF DESCRIPTION OF DRAWINGS

FIG. 1 is a block diagram illustrating an example of a configuration of a communication system;

FIG. 2 is a diagram illustrating an example of an office room in which the communication system is installed;

FIG. 3 is a diagram illustrating a configuration of a waveguide;

FIG. 4 is a diagram illustrating a simulation result;

FIG. 5A is a diagram illustrating a slot antenna apparatus according to a first variation of the embodiment;

FIG. 5B is a diagram illustrating the slot antenna apparatus according to the first variation of the embodiment;

FIG. 6 is a diagram illustrating a pad;

FIG. 7A is a diagram illustrating a slot antenna apparatus according to a second variation of the embodiment;

FIG. 7B is a diagram illustrating the slot antenna apparatus according to the second variation of the embodiment; and

FIG. 8 is a diagram illustrating a slot antenna apparatus according to a third variation of the embodiment.

### DESCRIPTION OF EMBODIMENT

Hereinafter, embodiments to which a slot antenna apparatus, and a method for adjusting an amount of radio waves emitted from the slot antenna apparatus are applied will be described.

### Embodiment

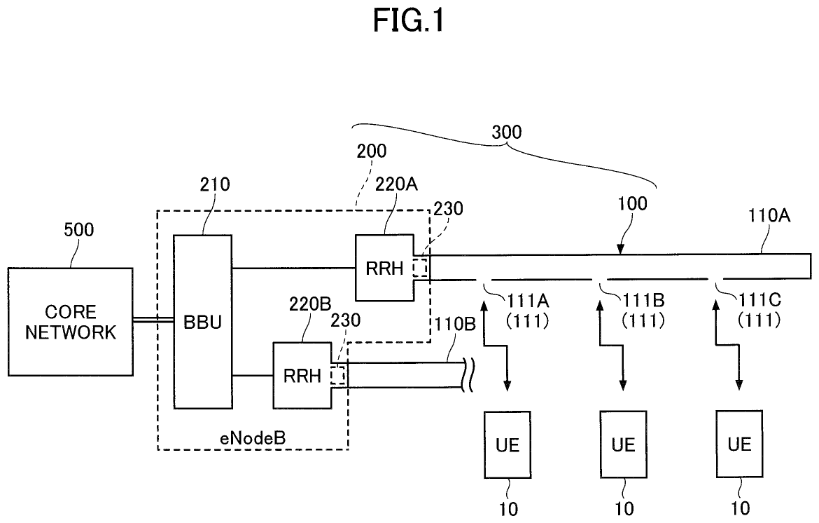

FIG. 1 is a block diagram illustrating an example of a configuration of a communication system 300. The communication system 300 includes a slot antenna apparatus 100 and an evolved Node B (eNodeB) 200. The communication system 300 is a system that adopts a cellular system and performs wireless communications.

The eNodeB 200 is an example of a base station which includes a base band unit (BBU) 210, remote radio heads (RRHs) 220A and 220B, and coaxial waveguide converters 230. The eNodeB 200 is connected to a core network 500 via optical fibers. The core network 500 is a high capacity communication line and is an example of a trunk network or backbone.

The BBU 210 is an apparatus that performs a baseband processing. The BBU 210 is provided in the eNodeB 200 and is connected to the RRHs 220A and 220B via the optical fibers.

The RRHs 220A and 220B are radio apparatuses. The RRHs 220A and 220B are provided in one eNodeB 200, and two RRHs 220A and 220B are as illustrated in FIG. 1. The RRHs 220A and 220B are connected to the waveguides 110A and 110B of the slot antenna apparatus 100, respectively, via the coaxial waveguide converters 230. Each of the waveguides 110A and 110B is an example of a waveguide and is made of metal.

In a case where the RRHs 220A and 220B are not specifically distinguished, the RRH of the present embodiment is referred to as an RRH 220. In a case where the waveguides 110A and 110B are not specifically distinguished, the waveguide of the present embodiment is referred to as a waveguide 110.

The coaxial waveguide converters 230 connect coaxial cables of the RRHs 220A and 220B and the waveguides 110A and 110B of the slot antenna apparatus 100, respectively. The coaxial waveguide converters 230 are transducers that can perform bi-directional power conversion between the coaxial cables and the waveguides 110A and 110B.

The slot antenna apparatus 100 includes the waveguides 110A and 110B. The waveguide 110A includes slots 111 (111A to 111C). Although slots of the waveguide 110B are omitted in FIG. 1, the waveguide 110B includes the slots similar to the slots 111 (111A to 111C). Although the waveguide 110A includes the three slots 111 (111A to 111C), for example, the number of the slots 111 is not limited to three. One of the slots 111A to 111C is an example of a first slot, and another one of the rest two of the slots 111A to 111C is an example of a second slot.

The slot 111A is closest to the RRH 220A and the slot 111C is farthest away from the RRH 220A. Hereinafter, in a case where the slots 111A to 111C are not specifically distinguished, the slot of the present embodiment is referred to as a slot 111.

The waveguide 110 is connected to the RRH 220 via the coaxial waveguide converter 230. The slots 111A to 111C emit (output) radio waves propagating inside the waveguide 110 to an exterior of the waveguide 110 and provide communication areas in which a cellular equipment can perform the wireless communications.

A user equipment (UE) 10 receives the radio waves emitted from slots 111A to 111C in the communication areas and can perform bi-directional data communication with the core network 500 via the waveguide 110 and the eNodeB 200.

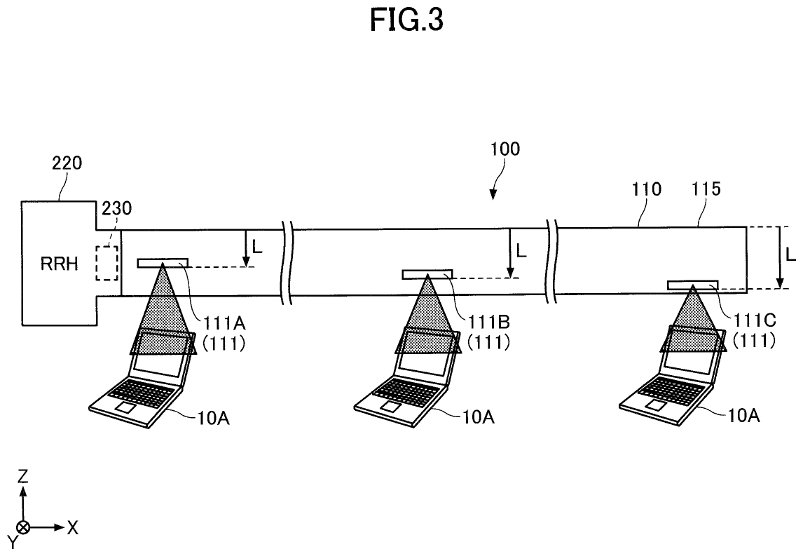

The slot antenna apparatus 100 has a configuration which enables the user to set or adjust the amount of the radio waves emitted from each of the slots 111A to 111C. Details of the slot antenna apparatus 100 will be described below with reference to FIG. 3. The amount of the radio waves corresponds to an intensity of the radio waves and defines sizes of the communication areas.

The UE 10 is, for example, a personal computer (PC), a tablet computer, a smartphone, and other devices that can perform the wireless communications in the cellular system.

Although an embodiment in which the communication system 300 adopts the cellular system will be described, for example, the communication system 300 may adopt a wireless local area network (LAN) system. In a case where the communication system 300 adopts the wireless LAN system, the communication system 300 includes an access point (AP) instead of the eNodeB 200 and connects to the Internet instead of the core network 500 so that a terminal similar to the UE 10 can perform data communication. The terminal used in the wireless LAN system may be referred to as a station.

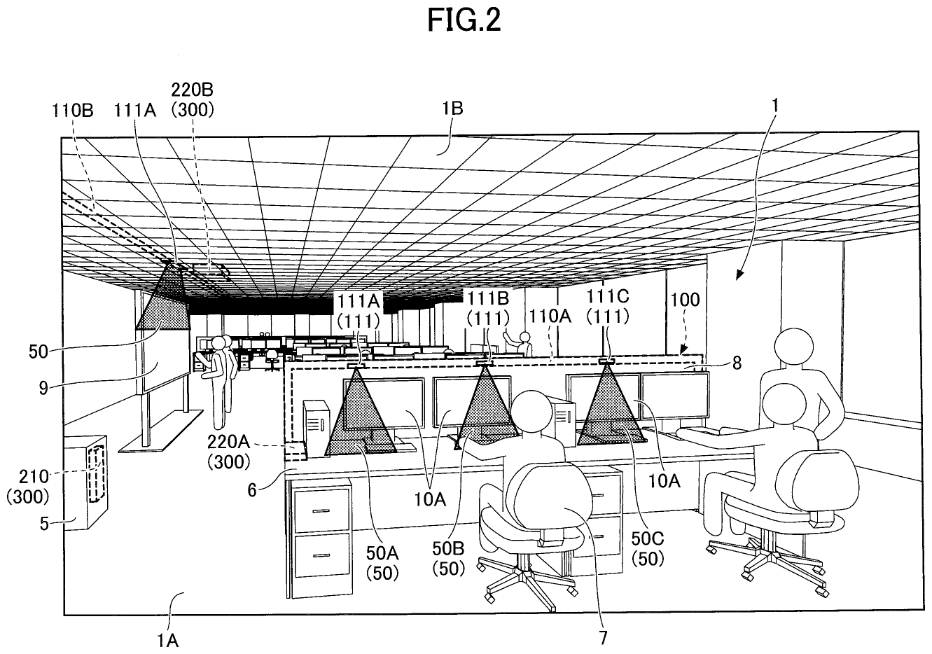

FIG. 2 is a diagram illustrating an example of an office room 1 in which the communication system 300 is installed. FIG. 2 illustrates a shelf 5, desks 6, chairs 7, partitions 8, and a large monitor 9 or the like that are arranged on a floor 1A of the office room 1. PCs 10A are arranged on the desks 6. Employees are working in the office room 1.

The BBU 210 is disposed in the shelf 5 as an example, the RRH 220A is installed in one of the desks 6, and the RRH 220B is disposed in a rear side of a ceiling 1B. In FIG. 2, the optical fibers connecting the BBU 210 and the RRHs 220A and 220B and the coaxial waveguide transducer 230 (see FIG. 1) are omitted. The RRH 220A may be installed under the floor 1A.

The waveguide 110A connected to the RRH 220A is installed along side and upper edges of the partitions 8 provided between the opposite desks 6 and has the slots 111A to 111C. The slots 111A to 111C emit the radio waves toward the desks 6 and provide communication areas 50 (50A to 50C), respectively. PCs 10A are disposed on the desks 6 and can perform the wireless communications through the radio waves emitted from the slots 111A to 111C. The waveguide 110A may be embedded in upper surfaces of the desks 6. In this case, the slots 111A to 111C may be exposed on the upper surfaces of the desks 6.

The slots 111A to 111C may be assigned for three employees working at desks 6, for example. Thus, pitches among the slots 111A to 111C correspond to pitches between workspaces of the employees at the desks 6, for example.

The pitches of the slots 111A to 111C as described above are largely different from conventional pitches between slots of a typical slot antenna. The conventional pitches are about a half wavelength to about one wavelength at a communication frequency. The pitches of the slots 111A to 111C are greater than or equal to ten wavelengths at the communication frequency. In a case where the slots 111A to 111C are arranged at pitches that are greater than or equal to ten wavelengths, the radio waves emitted from the adjacent slots 111A to 111C are unlikely to interfere with each other. It becomes possible to obtain the communication areas 50A to 50C that are independent of each other.

The waveguide 110B connected to the RRH 220B is disposed in the rear side of a ceiling 1B, and the slot 111A of the waveguide 110B is exposed on the ceiling 1B. The slot 111A of the waveguide 110B emits the radio waves to the large monitor 9 and provides the communication area 50. The large monitor 9 is disposed in the communication area 50 provided by the radio waves emitted from the slot 111A of the waveguide 110B and can perform the wireless communication. The large monitor 9 displays data received in the communication area 50 provided by the slot 111A of the waveguide 110B through the wireless communication.

As described above, the communication system 300 includes the waveguide 110. The waveguide 110 has an advantage of low transmission losses, particularly in a case of transmitting data at a high frequency band (e.g., millimeter-wave band). This is an advantage of the waveguide 110 over coaxial cables which have very high transmission losses at the high frequency band, such as the millimeter-wave band. Herein, the millimeter-wave band is, for example, a frequency band ranging from about 30 GHz to about 300 GHz. An example of a cellular communication using the millimeter-wave band is a fifth generation (5G). 5G uses a 28 GHz band and a 39 GHz band. A WiFi system uses 60 GHz band provided by IEEE 802.11ad (WiGig). It should be noted that the communication system 300 is not limited to communication in the millimeter-wave band(s), but may be used for communication in bands other than the millimeter-wave band(s).

FIG. 3 is a diagram illustrating a configuration of the waveguide 110. Hereinafter, a common XYZ orthogonal coordinates system will be used to explain the configuration. The waveguide 110 is a rectangular waveguide and has the slots 111A to 111C arranged along an extending direction (the X direction) of the waveguide 110. A cross-sectional shape obtained in the YZ plane of the waveguide 110 is a rectangular shape having short sides extending in the Y direction and long sides extending in the Z direction. The cross-sectional shape in the YZ plane is a cross-sectional shape obtained in a plane perpendicular to the extending direction (the X direction). Accordingly, FIG. 3 illustrates a sidewall including the long sides of the waveguide 110.

The slots 111A to 111C are rectangular openings formed in the sidewall including the long sides. The slots 111A to 111C have longitudinal directions extending along the extending direction (the X direction) of the waveguide 110. The extending direction (the X direction) of the waveguide 110 is the longitudinal direction of the waveguide 110. However, opening shapes of the slots 111A to 111C are not limited to rectangular shapes, the slots 111A to 111C may have rounded long sides and/or rounded short sides, for example. As an example, the waveguide 110 has the three slots 111 (111A to 111C), but the number of slots 111 is not limited three.

The length of the slot 111 in the longitudinal direction (the X direction) of the slot 111 is about a half of the wavelength (about one half of the wavelength) at the communication frequency of the slot antenna apparatus 100. The width of the slot 111 in a short side direction (the Z direction) of the slot 111 may be set to an appropriate width based on emission characteristics or the like of the slot 111.

The waveguide 110 has a length in the extending direction (the X direction) and a width in the Z direction. The slot 111A is provided at a position which is slightly offset to the −Z direction from a center of the width of the waveguide 110. The slots 111B and 111C are provided at positions which are offset to the −Z direction from the center of the width of the waveguide 110. The offset of the slot 111B from the center is greater than the offset of the slot 111A from the center, and the offset of the slot 111C from the center is greater than the offset of the slot 111B from the center. The positions of the slots 111A to 111C are offset to the −Z direction with respect to the center of the width of the waveguide 110. Herein, the length L is defined by using an edge 115 as illustrated in FIG. 3. The edge 115 is an edge of the waveguide 110. The edge 115 is located on +Z direction side of the waveguide 110 and is extending in the X direction.

The length L is a length from the edge 115 to each of −Z direction-side-edges of the slots 111A to 111C. The −Z direction-side-edges of the slots 111A to 111C are −Z direction-side-edges of the openings of the slots 111A to 111C, respectively.

The lengths L of the slots 111A to 111C are different from each other. The length L of the slot 111A is the shortest, and the length L of the slot 111C is the longest. The length L of the example of the first slot among the slots 111A to 111C is an example of a first length, and the length L of the example of the second slot among the slots 111A to 111C is an example of a second length.

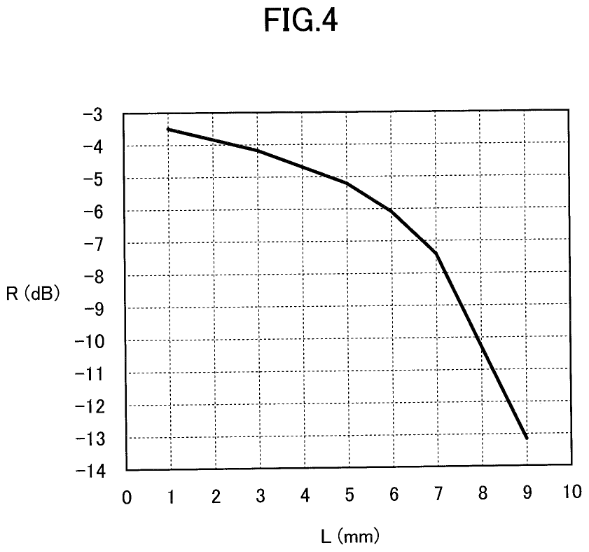

FIG. 4 is a diagram illustrating a simulation result representing the relationship between the length L and an emission amount R of the slot 111. FIG. 4 illustrates the results obtained by an electromagnetic field simulation while varying the length L from 1 mm to 9 mm. The emission amount R of the slot 111 is an emission amount of the radio waves emitted from the slot 111.

In a case where the length L is 9 mm, the −Z direction-side-edge of the slot 111 is matched with the center of the width in the Z direction of the waveguide 110. Accordingly, in a case where the length L is in a range from 1 mm to 9 mm, the center of the width of the slot 111 in the Z direction is offset to the +Z direction with respect to the center of the width of the waveguide 110 in the Z direction.

As the length L is increased from 1 mm to 9 mm, the amount R tends to decrease. This indicates that a degree of coupling between the waveguide 110 and the slot 111 varies in accordance with the length L which represents the position of the slot 111 in the Z direction. As the position of the slot 111 approaches the edge(s) of the waveguide 110 in the Z direction, the coupling becomes stronger. In other words, as the position of the slot 111 approaches edge side(s) of the waveguide 110 in the Z direction, the coupling becomes stronger. As the position of the slot 111 approaches the center of the waveguide 110 in the Z direction, the coupling becomes weaker. In other words, as the position of the slot 111 approaches a central side of the waveguide 110 in the Z direction, the coupling becomes weaker. The Z direction corresponds to the extending directions of the long sides of the rectangular cross-sectional shape of the waveguide 110 obtained in the YZ plane.

In a case where the slots 111A to 111C are all provided at the same position in the Z direction, the emission amount of the slot 111A, which is closest to the RRH 220A, becomes greatest, and the emission amount of the slot 111C, which is farthest from the RRH 220A, becomes smallest. The waveguide 110 is a waveguide with small transmission losses, but the transmission losses are not zero. As the position of the slot 111 becomes farther, the transmission losses increase and the electric power being transmitted through the waveguide 110 decreases.

In a case where the emission amounts of the slots 111A to 111C increase, the communication areas 50A to 50C (see FIG. 2) provided by the rad io waves emitted from the slots 111A to 111C become wider. In a case where the emission amounts of the slots 111A to 111C decrease, the communication areas 50A to 50C (see FIG. 2) provided by the radio waves emitted from the slots 111A to 111C become narrower. Accordingly, in such a case, the communication area 50C provided by the slot 111C, which is farthest from the RRH 220A, becomes narrowest.

For example, in the office room 1 as illustrated in FIG. 2, the three PC 10A perform wireless communication via the radio waves emitted from the slots 111A to 111C of the waveguide 110 provided in the partition 8 of the desk 6. In a case where the slots 111A to 111C each emit the same amount of radio waves, it becomes possible to equalize the sizes of the three adjacent communication areas 50A to 50C.

For some applications, it may be desirable to set the sizes of the three adjacent communication areas 50A to 50C arbitrarily, i.e., not equally. For example, it may be desirable to maximize the size of the communication area 50C provided by the slot 111C among the communication areas 50A to 50C.

If it is possible to set the emission amounts of the slots 111A to 111C arbitrarily, it becomes possible to set the sizes of the three independent communication areas 50A to 50C arbitrarily and independently. Accordingly, it becomes possible to set the sizes and locations of the communication areas 50A to 50C in accordance with preferences of users of the communication system 300.

For example, it is possible to separate the adjacent communication areas 50A to 50C provided by the slots 111A to 111C, respectively, in accordance with the pitches of the slots 111A to 111C or the pitches of the desks 6. In this case, the three PCs 10A can independently perform wireless communication through the communication areas 50A to 50C, respectively. The communication system 300 can provide the independent communication areas 50A to 50C to the three users, respectively. The three users can occupy the independent communication areas 50A to 50C, respectively.

Therefore, in the present embodiment, the communication system 300 sets the amount of the radio waves emitted from the slots 111A to 111C by setting the positions of the slots 111A to 111C in the Z direction of the waveguide 110. For example, as illustrated in FIG. 3, in a case where the slots 111A to 111C are arranged in the positions from the central side to the edge side of the waveguide 110 in the Z direction in this order, it is possible to level the emission amounts of the slots 111A to 111C.

It is possible to set the emission amounts of the slots 111A to 111C in the Z direction in accordance with requirements of the users, by setting the positions of the slots 111A to 111C in the Z direction. The Z direction corresponds to the extending directions of the long sides of the rectangular cross-sectional shape of the waveguide 110 obtained in the YZ plane.

The positions of the slots 111A to 111C in the Z direction of the waveguide 110 can be set during the manufacture of the waveguide 110.

Accordingly, it is possible to provide the antenna apparatus 100 and the communication system 300 that can set the emission amounts of the radio waves emitted from the slot 111A to 111C.

Although the antenna apparatus 100 includes the waveguide 110 made of metal as described above, the waveguide 110 may be a waveguide realized by metal foils, such as aluminum foils, copper foils or the like, provided on the inner surfaces of a resin member of which the inner surfaces have the same shape as that of the waveguide 110.

Although the waveguide 110 includes the three slots 111 (111A to 111C) as described above, the number of the slots 111 may be any number as long as the waveguide 110 includes a plurality of the slots 111.

Although the positions of the three slots 111 (111A to 111C) are different from each other as described above, any two of the three slots 111 (111A to 111C) may be provided at the same position in the Z direction.

Although the longitudinal directions of the three slots 111 (111A to 111C) are equal to the longitudinal direction (the X direction) of the waveguide 110 as described above, the longitudinal directions of the three slots 111 (111A to 111C) may be angled with respect to the longitudinal direction (the X direction) of the waveguide 110. Each slot 111 may be angled at a different angle from the other slots.

Although the waveguide 110 is the rectangular waveguide as described above, the waveguide 110 may be a circular waveguide.

In the embodiment as described above, the amounts of the radio waves emitted from the slots 111A to 111C are set to designated amounts by setting the positions of the slots 111A to 111C in the Z direction.

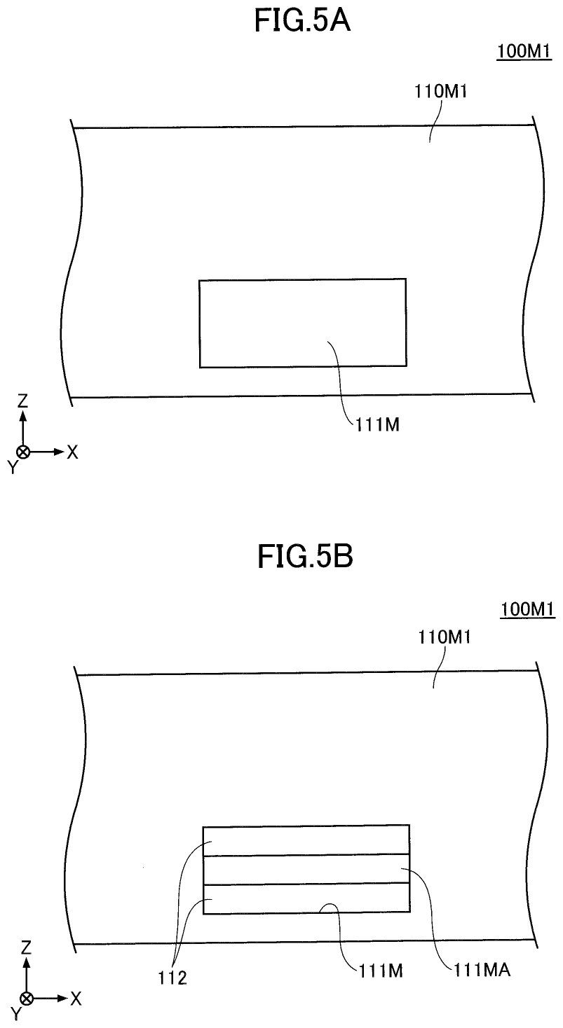

However, for example, a configuration as illustrated in FIGS. 5A and 5B makes it possible for the user(s) to adjust the emission amount(s). FIGS. 5A and 5B are diagrams illustrating a slot antenna apparatus 100M according to a first variation of the embodiment. The slot antenna apparatus 100M1 includes a waveguide 110M1. FIGS. 5A and 5B illustrate a part of the waveguide 110M1 in an extending direction.

As illustrated in FIG. 5A, the waveguide 110M1 includes a slot 111M having a width three times wider than the widths in the Z direction of the slots 111A to 111C as illustrated in FIG. 3. It is possible to adjust a position of a slot 111MA, which is realized by an effective opening within the slot 111M by mounting two panels 112 having strip shapes as illustrated in FIG. 5B. The width in the Z direction of the panel is the same as that of the slot 111. The waveguide 110M1 may include any number of the slot(s) 111M.

The panel 112 is an example of a metal panel. The panel 112 is a metal member which is made of the same metal as that of the waveguide 110M1. The panel 112 has a length in the X direction equal to the length in the X direction of the slot 111M, and a width in the Z direction which is one-third of the width in the Z direction of the slot 111M. The user can adjust the position of the slot 111MA realized by the effective opening by using the two panels 112 after the waveguide 110M1 is once made.

More specifically, in a case where the opening of the slot 111M is divided into three areas in the Z direction, the user can adjust the position of the slot 111MA in a center area among the three areas by mounting the two panels 112 into the area located in +Z direction-side and the area located in −Z direction-side as illustrated in FIG. 5B.

The user can adjust the position of the slot 111MA in the area located in the −Z direction-side by mounting the two panels 112 into the center area and the area located in +Z direction-side. The user can adjust the position of the slot 111MA in the area located in the +Z direction-side by mounting the two panels 112 into the center area and the area located in the −Z direction-side.

In this manner, the user can adjust the emission amount of the radio waves from the slot 111MA by selecting the positions of the two panels 112 within the three areas. It is possible to adjust the emission amount of the radio waves from the slot 111MA after the waveguide 111M1 has been assembled or installed. It is possible to form the slot 111A instead of the slots 111A to 111C of the waveguide 110 as illustrated in FIG. 3.

Accordingly, according to the first variation of the embodiment, it is possible to provide the slot antenna apparatus 100M1, a communication system including the slot antenna 100M1, and a method for adjusting the emission amount of the radio waves from the slot antenna apparatus 100M1 that can adjust the emission amount of the radio waves from the slot 111MA.

The width in the Z-direction of the panel 112, the number of panels 112, and the like are not limited to those illustrated herein, and can be changed as appropriate.

Next, a second variation and a third variation of the present embodiment will be described.

The emission amounts of the radio waves of the slots 111A to 111C may be adjusted to desired amounts by mounting a dielectric pad in at least one of the slots 111A to 111C.

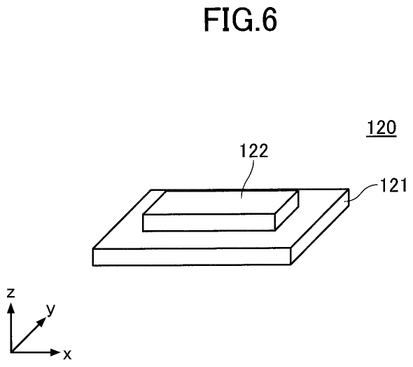

FIG. 6 is a diagram illustrating a pad 120. In FIG. 6, xyz orthogonal coordinates system represented by small letters will be used to explain a configuration of the pad 120.

The pad 120 is an example of a dielectric member which includes a base 121 and a protrusion 122 protruding from a center of one of the surfaces (a surface located in the +z direction-side) of the base 121. The base 121 is a thin flat plate-like member having a thickness in the z direction. A planar size of the protrusion 122 is smaller in the x direction and the y direction than the base 121, and a thickness in the z direction of the protrusion 122 is equivalent to that of the base 121, for example.

The size of the protrusion 122 in the xy plane view is matched to the size of the opening of the slot 111, and the size of the base 121 in the xy plane view is greater than the size of the opening of the slot 111. Therefore, in a case where the protrusion 122 is fitted into the slot 111, the slot 111 can be covered with the pad 120. Herein, fitting the protrusion 122 into the slot 111 and covering the slot 111 with the pad 120 is referred to as “mounting the pad 120 in the slot 111”. The pad 120 is mountable in the slot 111.

The pad 120 having the base 121 and a protrusion 122 may be manufactured by integrally molding dielectric materials such as a resin, for example. In a state where the pad 120 is mounted in the slot 111, the radio waves emitted from the slot 111 pass through the pad 120.

Accordingly, in a state where the pad 120 is mounted in the slot 111, the emission characteristics of slots 111 are affected by a loss tangent (tan δ) or a relative permittivity of the pads 120. The loss tangent or the relative permittivity is an example of a dielectric property. The dielectric property is a property of a dielectric member made of dielectric materials and affects the emission characteristics of the slot 111.

For example, if the user replaces the pad 120 with another pad 120 having a different loss tangent, emission losses which occur when the radio waves pass through the pad 120 are changed. As a result, the amount of the radio waves emitted from the slot 111 is changed. The emission losses increase as the loss tangent increases. The amount of the radio waves emitted from the slot 111 decrease as the emission losses increase. The emission losses correspond to a reduction amount of the emission amount of the radio waves from the slot 111. In a case where the user wants to increase the emission losses, the user may select a pad 120 made of dielectric materials having a greater loss tangent. In a case where the user wants to decrease the emission losses, the user may select a pad 120 made of dielectric materials having a lower loss tangent.

If a density of the dielectric materials used for forming the pad 120 is changed, the loss tangent of the pad 120 is changed, for example. Depending upon kinds of the dielectric materials used, in general, as the density increases, the loss tangent decreases. As the density decreases, the loss tangent increases. Various resin materials, such as a polyethylene or the like, may be used as the dielectric materials. One or more foreign substance(s) may also be incorporated into the dielectric materials to vary the loss tangent.

The wavelength shortening rate depends on the relative permittivity. If the user replaces the pad 120 with another pad 120 having a different relative permittivity, the resonant frequency of the slot 111 is changed. For example, in a case where the slot 111 without the pad 120 is designed to resonate at a frequency of the radio waves propagating through the waveguide 110, mounting the pad 120 in the slot 111 causes the radio waves emitted from the slot 111 to deviate from a resonant condition, thereby reducing the amount of the radio waves emitted from the slot 111.

As the relative permittivity increases, the wavelength shortening rate increases. In a case where the user wants to increase the emission losses, the user may select the pad 120 made of dielectric materials having a greater relative permittivity. In a case where the user wants to decrease the emission losses, the user may select the pad 120 made of dielectric materials having a smaller relative permittivity.

In order to change the relative permittivity of the pad 120, kinds of the dielectric materials used for forming the pad 120 may be changed. The relative permittivity of the dielectric materials varies depending on a density or the like. Accordingly, the relative permittivity of the dielectric materials can be changed by changing the density or the like of the dielectric materials used for forming the pad 120. One or more foreign material(s) may also be incorporated into the dielectric materials to change the relative permittivity.

According to the embodiment as described above, the pad 120 covers the entire opening of the slot 111. However, the pad 120 may cover a part of the opening of the slot 111. The pad 120 having such a configuration may be mounted in the slot 111.

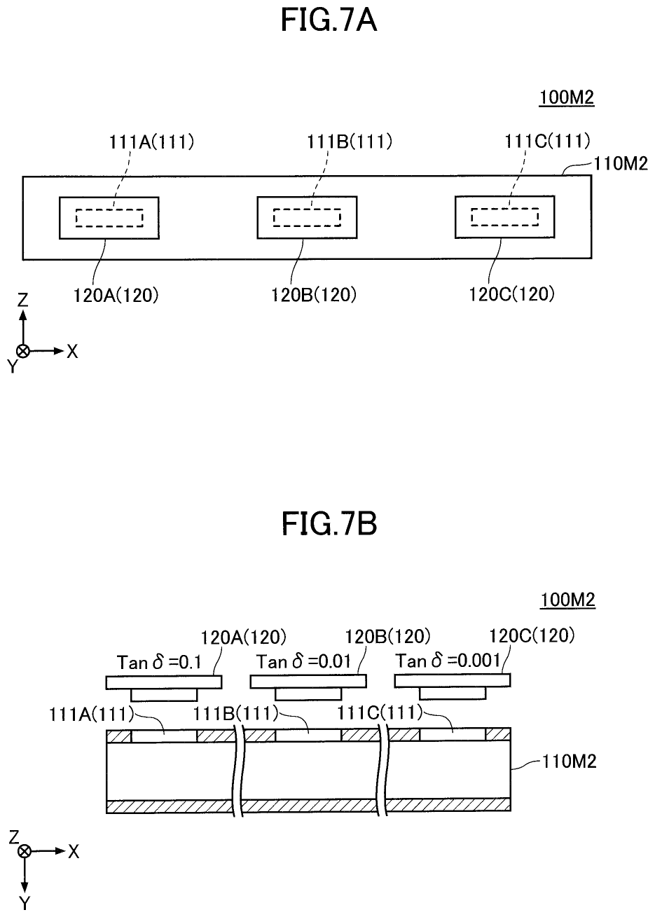

FIGS. 7A and 7B are diagrams illustrating a slot antenna apparatus 100M2 according to a second variation of the embodiment. The slot antenna apparatus 100M2 includes a waveguide 110M2 and pads 120A to 120C. The waveguide 110M2 includes the slots 111A to 111C. A communication system according to the second variation of the embodiment includes the slot antenna apparatus 100M2 instead of the slot antenna apparatus 100 included in the communication system 300 as illustrated in FIG. 1. Hereinafter, the pads 120A to 120C are referred to as pads 120, unless specifically distinguished.

FIG. 7A illustrates the waveguide 110M2 to which the pads 120A to 120C are mounted, and FIG. 7B illustrates a cross-sectional structure in a state where the pads 120A to 120C are not mounted in the slots 111A to 111C of the waveguide 110M2. As illustrated in FIG. 7A, the slots 111A to 111C are all provided at the same position in the Z direction (the width direction of the waveguide 110). Because the amount of the radio waves emitted from the slots 111A to 111C can be adjusted by the pads 120A to 120C, respectively, the slots 111A to 111C are all provided at the same position in the Z direction.

Here, the loss tangent (tan δ) will be used as the example of the dielectric property. One of the pads 120A to 120C is an example of a first dielectric member and another one of the rest two of the pads 120A to 120C is an example of a second dielectric member. The dielectric property of the example of the first dielectric member among the pads 120A to 120C is an example of a first dielectric property. The dielectric property of the example of the second dielectric member among the pads 120A to 120C is an example of a second dielectric property.

As an example, the loss tangents (tan δ) of the pads 120A to 120C are different from each other. The loss tangents (tan δ) of the pads 120A, 120B, and 120C are 0.1, 0.01, and 0.001, respectively. In other words, the pad 120A causes the greatest emission losses, and thus the pad 120A causes the greatest reduction in the emission amount of the radio waves. The pad 120C causes the least emission losses, and thus the pad 120C causes the least reduction in the emission amount of the radio waves.

In a state where the pads 120A to 120C are not mounted in the slots 111A to 111C, the emission amount of the slot 111A is the greatest, and the emission amount of the slot 111C is the smallest. It is possible to change distribution of the emission amounts of the slots 111A to 111C by mounting the pads 120A to 120C therein, respectively, compared to the state without mounting the pads 120A to 120C in the slots 111A to 111C. Accordingly, the user(s) can adjust the distribution of the emission amounts of the slots 111A to 111C by mounting the pads 120A to 120C therein, respectively. This is accomplished by the method for adjusting the amount of the radio waves emitted from the slot antenna apparatus 100.

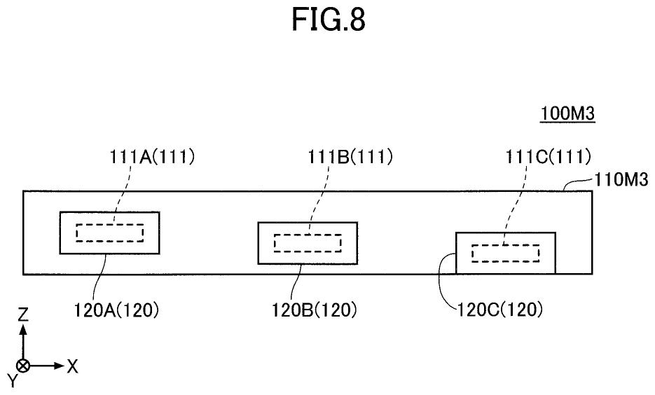

FIG. 8 is a diagram illustrating a slot antenna apparatus 100M3 according to a third variation of the embodiment. The slot antenna apparatus 100M3 includes a waveguide 110M3 and the pads 120A to 120C. A communication system according to the third variation of the embodiment includes the slot antenna apparatus 100M3 instead of the slot antenna apparatus 100 included in the communication system 300 as illustrated in FIG. 1.

The positions in the Z direction (the width direction) of the slots 111A to 111C of the waveguide 110M3 are different from the positions in the Z direction of the slots 111A to 111C of the waveguide 110. The slot 111A is the closest to the center of the width of the waveguide 110M3. The slot 111C is located in outermost side. Accordingly, the slots 111A to 111C are arranged in the positions from the central side to the edge side of the waveguide 110M3 in the Z direction in this order. The arrangement of the slots 111A to 111C as illustrated in FIG. 8 is the same as that of the slots 111A to 111C as illustrated in FIG. 3.

For example, distribution of the emission amounts of the slots 111A to 111C of the waveguide 110M3 is set in a state where the pads 120A to 120C are not mounted in the slots 111A to 111C. It is possible to change the distribution of the emission amounts of the slots 111A to 111C by mounting the pads 120A to 120C therein, respectively. Accordingly, the user(s) can adjust the distribution of the emission amounts of the slots 111A to 111C by mounting the pads 120A to 120C therein, respectively. This is accomplished by the method for adjusting the amount of the radio waves emitted from the slot antenna apparatus 100.

In the second variation (see FIG. 7) and the third variation (see FIG. 8), it is not necessary to mount the pads 120A to 120C in the slots 111A to 111C, respectively. For example, any one or two of the pads 120A to 120C may be mounted in corresponding any one or two of the slots 111A to 111C.

Herein, meanings of terms “any one of the pads 120A to 120C is mounted in corresponding any one of the slots 111A to 111C” are as follows. In the slot antenna apparatuses 100M2 and 100M3, the user performs any one of following three actions: to mount the pad 120A in the slot 111A, to mount the pad 120B in the slot 111B, and to mount the pad 120C in the slot 111C.

The meaning of terms “any two of the pads 120A to 120C are mounted in corresponding any two of the slots 111A to 111C” are as follows. In the slot antenna apparatuses 100M2 and 100M3, the user performs any two of the following three actions: to mount the pad 120A in the slot 111A, to mount the pad 120B in the slot 111B, and to mount the pad 120C in the slot 111C.

In a case where the user performs any one or two of the three actions as described above, it is possible to adjust the emission amount(s) of one or two of the slots 111A to 111C.

Instead of mounting the pads 120A to 120C having the different loss tangents from each other in the slots 111A to 111C, respectively, the pads 120A to 120C may be mounted in the slots 111A to 111C in arbitrary combinations. This is possible in a case where the slots 111A to 111C have the same opening sizes and shapes with each other and the protrusions 122 (see FIG. 6) of the pads 120A to 120C have the same sizes and shapes.

Meanings of terms “the pads 120A to 120C are mounted in the slots 111A to 111C in arbitrary combinations” are as follows. The user mounts a first pad of the pads 120A to 120C in the slot 111A, mounts a second pad of the pads 120A to 120C in the slot 111B, and mounts a third pad of the pads 120A to 120C in the slot 111C.

If the pads 120A to 120C having the different loss tangents from each other are mounted in the slots 111A to 111C in arbitrary combinations, it is possible to adjust the sizes of the communication areas 50A to 50C (see FIG. 2) provided by the slots 111A to 111C in various patterns.

For example, it is possible for the user to adjust the size of any particular communication area 50 by selecting any one of the pads 120 (120A to 120C) and mounting the selected pad 120 in any one of the slots 111A to 111C in accordance with a situation where the user uses the PC 10A.

Further, in a case where the communication system includes a plurality of the pads 120 which can be mountable in each of the slots 111A to 111C and which have plural kinds of the dielectric properties, and where the communication system informs the user(s) of the sizes of the communication areas 50 obtained by combinations of the slots 111A to 111C and the pads 120, it is possible for the user(s) to adjust the sizes of the communication areas 50 in accordance with situation(s) where the user(s) uses the PC(s) 10A.

As described above, according to the second and the third variations of the embodiment, it is possible to adjust the emission amount of the slot 111 (at least any one of the slots 111A to 111C) by mounting the pad 120 in the slot 111. Further, it is possible to adjust the emission amount of the slot 111 by replacing the pad 120 to another pad 120 having the different dielectric property. The user can adjust the emission amount in a manner as described above after the slot antenna apparatuses 100M2 and 100M3 have been assembled or installed.

Accordingly, it is possible to provide the slot antenna apparatuses 100M2 and 100M3, the communication system including the slot antenna apparatuses 100M2 and 100M3, and the method for adjusting the emission amounts of the slot antenna apparatuses 100M2 and 100M3 that can adjust the emission amount(s).

According to the embodiment as described above with respect to FIGS. 7A, 7B, and 8, the pads 120A to 120C have the different loss tangents from each other. The same applies to cases where the pads 120A to 120C have the different relative permittivities.

In the above description, a slot antenna apparatus, and a method for adjusting an amount of radio waves emitted from a slot antenna apparatus according to embodiments are described. However, the present invention is not limited to the embodiments specifically disclosed. A person skilled in the art may easily achieve various modification and changes without departing from the scope of the present invention.

The other objects, features, and benefits of the present application may become further clear by referring to the accompanying drawing and embodiments described above.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of superiority or inferiority of the invention. Although the embodiment of the present invention has been described in detail, it should be understood that various changes, substitutions, and alterations could be made hereto without departing from the sprit and scope of the invention.

What is claimed is:

1. A slot antenna apparatus comprising:
a waveguide including a sidewall having an edge;
a first slot provided on the sidewall;
a second slot provided on the sidewall; and
a first dielectric member mountable in the first slot or the second slot, the first dielectric member having a first dielectric property.

2. The slot antenna apparatus as claimed in claim 1, wherein the first dielectric property is a loss tangent or a relative permittivity of the first dielectric member.

3. The slot antenna apparatus as claimed in claim 1, wherein a first distance, between the first slot and the edge, and a second distance, between the second slot and the edge, are different from each other.

4. The slot antenna apparatus as claimed in claim 1, further comprising:
a second dielectric member mountable in the first slot or the second slot, the second dielectric member having a second dielectric property.

5. The slot antenna apparatus as claimed in claim 4,
wherein the first slot and the second slot have the same size and shape,
wherein the first dielectric member is mountable in any one of the first slot and the second slot, and
wherein the second dielectric member is mountable in any one of the first slot and the second slot.

6. The slot antenna apparatus as claimed in claim 4, wherein the second dielectric property is a loss tangent or a relative permittivity of the second dielectric member.

7. The slot antenna apparatus as claimed in claim 4, wherein the first dielectric property is different from the second dielectric property.

8. The slot antenna apparatus as claimed in claim 4,
wherein the first dielectric property is a loss tangent or a relative permittivity of the first dielectric member, and
wherein the second dielectric property is a loss tangent or a relative permittivity of the second dielectric member.

9. A slot antenna apparatus comprising:
a waveguide including a sidewall having an edge;
a first slot provided on the sidewall; and
a second slot provided on the sidewall,
wherein a first distance between the first slot and the edge and a second distance between the second slot and the edge are different from each other.

10. The slot antenna apparatus as claimed in claim 9, further comprising:
a first dielectric member mountable in the first slot or the second slot and having a first dielectric property.

11. The slot antenna apparatus as claimed in claim 10, wherein the first dielectric property is a loss tangent or relative permittivity of the first dielectric member.

12. The slot antenna apparatus as claimed in claim 10, further comprising:
a second dielectric member mountable in the first slot or the second slot, the second dielectric member having a second dielectric property.

13. The slot antenna apparatus as claimed in claim 12,
wherein the first slot and the second slot have the same size and shape,
wherein the first dielectric member is mountable in any one of the first slot and the second slot, and
wherein the second dielectric member is mountable in any one of the first slot and the second slot.

14. The slot antenna apparatus as claimed in claim 12, wherein the second dielectric property is a loss tangent or a relative permittivity of the second dielectric member.

15. The slot antenna apparatus as claimed in claim 12, wherein the first dielectric property is different from the second dielectric property.

16. A method for adjusting an amount of radio waves emitted from a slot antenna apparatus, the slot antenna apparatus including a waveguide having a sidewall, a first slot provided on the sidewall, a second slot provided on the sidewall, and a dielectric member mountable in the first slot or the second slot, the dielectric member having a designated dielectric property, the method comprising:
mounting the dielectric member in the first slot or the second slot to adjust an amount of radio waves emitted from the first slot or the second slot.
